(19) United States
(12) Patent Application Publication
(10) Pub. No.: US 2006/0040654 A1
(43) Pub. Date: Feb. 23, 2006

(54) Method of system for testing a wireless device

(76) Inventors: George S. Moore, Veradale, WA (US); John McLaughlin, Santa Rosa, CA (US); Joseph M. Gorin, Santa Rosa, CA (US); Moray D. Rumney, Edinburgh (GB); Matthew Johnson, Spokane, WA (US); Robert Locascio, Crystal Lake, IL (US); Peter J. Cain, Lasswade Midlothian (GB); David H. Molinari, Newman Lake, WA (US); Jochen Rivoir, Magstadt (DE)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 10/920,471

(22) Filed: Aug. 17, 2004

(51) Int. Cl. H04Q 7/20

(52) U.S. Cl. 455/423

(57) ABSTRACT

A wireless data communications link connects a wireless device to a test station. The test station transmits command and control parameters to the wireless device using the wireless data communications link. The command and control parameters place the wireless device in a test mode and test the quality and operations of a radio frequency (RF) link established between the wireless device and the test station. The wireless data communications link is also used to transmit test and control parameters from the wireless device to the test station.

### BACKGROUND

In order to ensure wireless devices are reliable and perform at a desired quality level, manufacturers perform various tests on their products. The tests are typically performed by connecting a wireless device, such as a cellular telephone, to a test station. The test station tests the wireless device by transmitting and receiving command and control parameters to and from the wireless device. Manufacturers of wireless devices typically want to test each wireless device as quickly as possible to improve manufacturing throughput.

FIG. 1 is a block diagram of a first testing system in accordance with the prior art. Testing system 100 includes test station 102 and wireless device 104. Wireless device 104 is typically seated in a test fixture (not shown) during product testing. Test station 102 includes transceiver 106 and wireless device 104 includes transceiver 108. To test wireless device 104, transceiver 106 establishes a radio frequency (RF) link 110 with transceiver 108. Testing station 102 then transfers and receives command and control parameters over link 110 using standard communication protocols.

Unfortunately, the standard communication protocols do not always allow wireless device 104 to be placed in all desired testing modes. The protocols are also not designed to rapidly change the state of wireless device 104 for efficient testing. And finally, it can be difficult to return test results from wireless device 104 to test station 102 using the standard communication protocols.

FIG. 2 is a second testing system in accordance with the prior art. Testing system 200 includes test station 202 and wireless device 204. Test station 202 includes transceiver 206 and wireless device 204 includes transceiver 208 and dedicated test connector 210. Connector 210 connects wireless device 204 to test station 202 using cable 212. Dedicated test connector 210 is used to place wireless device 204 in test mode and perform one or more test procedures on RF link 214. Unfortunately, dedicated test connector 210 can increase the cost of wireless device 204. Additionally, as the size of wireless devices decreases, it may become difficult to include a dedicated test connector in wireless device 204.

### SUMMARY

In accordance with the invention, a method and system for testing a wireless device are provided. A wireless data communications link connects a wireless device to a test station. The test station transmits command and control parameters to the wireless device using the wireless data communications link. The command and control parameters place the wireless device in a test mode and test the quality and operations of an RF link established between the wireless device and the test station. The wireless data communications link is also used to transmit test and control parameters from the wireless device to the test station.

### BRIEF DESCRIPTION OF THE DRAWINGS

The invention will best be understood by reference to the following detailed description of embodiments in accordance with the invention when read in conjunction with the accompanying drawings, wherein:

FIG. 1 is a block diagram of a first testing system in accordance with the prior art;

FIG. 2 is a block diagram of a second testing system in accordance with the prior art; and

FIG. 3 is a block diagram of a first testing system in an embodiment in accordance with the invention; and

FIG. 4 is a block diagram of a second testing system in an embodiment in accordance with the invention.

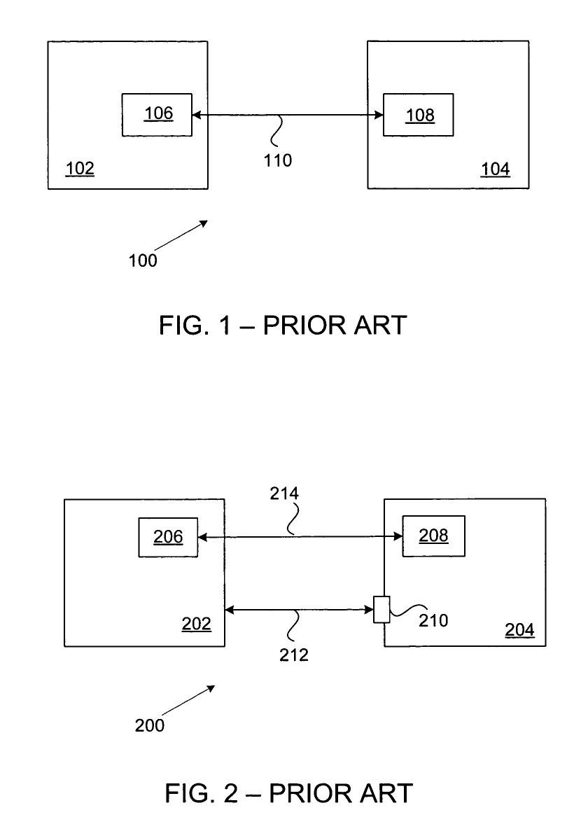

### DETAILED DESCRIPTION

The following description is presented to enable one skilled in the art to make and use embodiments of the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein.

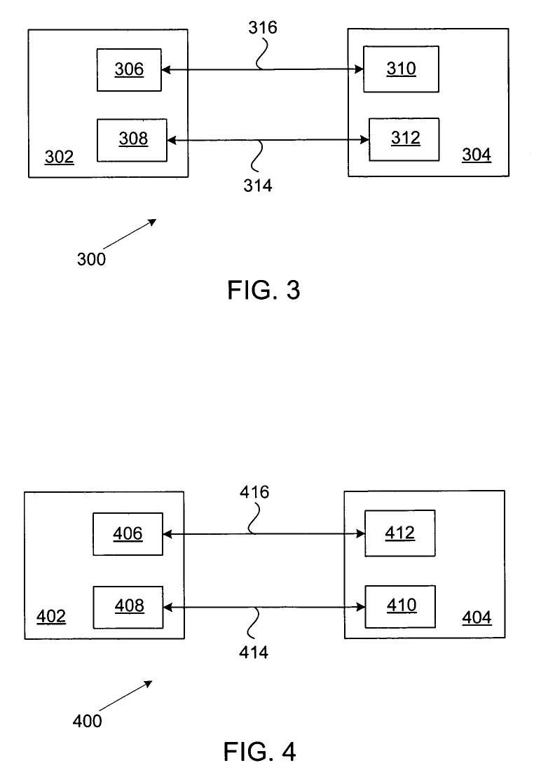

With reference to the figures and in particular with reference to FIG. 3, there is shown a block diagram of a first testing system in an embodiment in accordance with the invention. Testing system 300 includes test station 302 and wireless device 304. Test station 302 includes transceiver 306 and audio transducer 308 and wireless device 304 includes transceiver 310 and audio transducer 312. In one embodiment in accordance with the invention, transducer 308 is constructed within test station 302. Transducer 308 may also be implemented outside of test station 302 in other embodiments in accordance with the invention.

Test station 302 uses wireless data communications link 314 to transfer command and control parameters to wireless device 304. Command and control parameters place wireless device 304 in a test mode and test the quality and operations of RF link 316 established between transceiver 306 and transceiver 310. Control and test parameters are also transmitted from wireless device 304 to test station 302 via wireless data communications link 314.

In one embodiment in accordance with the invention, wireless device 304 is implemented as a cellular telephone and audio transducer 312 as one or more microphones and speakers. Audio transducers 308, 312 establish an acoustical coupling and use one or more audio channels to communicate and transfer command and control parameters. Wireless data communications link 314 may be implemented using any desired audio communications system. For example, wireless data communications link 314 may be configured as a modem connection with V.42bis functionality. Wireless data communications link 314 may be implemented with other types of modem standards or other types of audio communications systems in other embodiments in accordance with the invention.

FIG. 4 is a block diagram of a second testing system in an embodiment in accordance with the invention. Testing system 400 includes test station 402 and wireless device 404. Test station 402 includes transceiver 406 and wireless communications port 408. Wireless communications port 408 may be constructed within test station 402 in some embodiments in accordance with the invention. In other embodiments in accordance with the invention, wireless communications port 408 may be an external wireless communications port connected to test station 402.

Wireless device 404 includes wireless communications port 410 and transceiver 412. Communications port 410 may be implemented in wireless device 404, in a test fixture (not shown) holding wireless device 404, or external to the test fixture. Wireless communications port 410 is implemented as an alternate wireless communications medium and includes, but is not limited to, a Bluetooth® adapter, an infrared (IR) adapter, or wireless local area network (LAN) adapter such as an IEEE 802.11 adapter.

Wireless data communications link 414 is used to transfer command and control parameters to wireless device 404. Command and control parameters place wireless device 404 in a test mode and test the quality and operations of RF link 416 established between transceiver 412 and transceiver 406. Test and control parameters are also transmitted from wireless device 404 to test station 402 via wireless data communications link 414.

1. A method for testing a wireless device, comprising:
establishing a wireless data communications link with the wireless device;
transferring command and control parameters to and from the wireless device using the wireless data communications link; and
testing an RF link established with the wireless device based on the command and control parameters transferred over the wireless data communications link.

2. The method of claim 1, further comprising transferring test and control parameters from the wireless device to a test station using the wireless data communications link.

3. The method of claim 2, wherein testing an RF link established with the wireless device comprises testing an RF link established between the test station and the wireless device.

4. The method of claim 2, wherein establishing a wireless data communications link comprises establishing a wireless data communications link using one or more audio transducers in the wireless device and one or more audio transducers in the test station.

5. The method of claim 2, wherein establishing a wireless data communications link comprises establishing a wireless data communications link using one or more wireless communication ports associated with the wireless device and one or more wireless communication ports associated with the test station.

6. The method of claim 4, wherein the one or more wireless communications ports in the test station and in the wireless device both comprise a wireless network port.

7. The method of claim 6, wherein each wireless network port comprises a Bluetooth® port.

8. The method of claim 5, wherein the wireless communication port in the test station and in the wireless device comprise an audio transducer.

9. The method of claim 5, wherein the wireless communications port in the test station and in the wireless device comprise an infrared port.

10. A system for testing a wireless device, comprising:
a test station;
a wireless device;
a wireless data communications link connecting the wireless device to the test station; and
an RF link connecting the wireless device to the test station.

11. The system of claim 10, wherein the wireless data communications link comprises one or more audio channels.

12. The system of claim 10, wherein the wireless data communications link comprises an infrared link.

13. The system of claim 10, wherein the wireless data communications link comprises a wireless network link.

14. The system of claim 10, wherein the wireless data communications link comprises a Bluetooth link.

15. The system of claim 10, wherein the wireless data communications link comprises an IEEE 802.11 link.
